(19) United States
(12) Patent Application Publication
(10) Pub. No.: US 2012/0143789 A1
(43) Pub. Date: Jun. 7, 2012

(54) CLICK MODEL THAT ACCOUNTS FOR A USER'S INTENT WHEN PLACING A QUIERY IN A SEARCH ENGINE

(75) Inventors: Gang Wang, Beijing (CN); Weizhu Chen, Beijing (CN); Zheng Chen, Beijing (CN)

(73) Assignee: MICROSOFT CORPORATION, Redmond, WA (US)

(21) Appl. No.: 12/957,521

(22) Filed: Dec. 1, 2010

(51) Int. Cl. G06F 17/30; G06F 15/18; G06N 5/02

(52) U.S. Cl. 706/12; 707/728; 706/52; 707/E17.014

(57) ABSTRACT

A method of generating training data for a search engine begins by retrieving log data pertaining to user click behavior. The log data is analyzed based on a click model that includes a parameter pertaining to a user intent bias representing the intent of a user in performing a search in order to determine a relevance of each of a plurality of pages to a query. The relevance of the pages is then converted into training data.

### BACKGROUND

It has become common for users of host computers connected to the World Wide Web (the “web”) to employ web browsers and search engines to locate web pages having specific content of interest to users. A search engine, such as Microsoft's Live Search, indexes tens of billions of web pages maintained by computers all over the world. Users of the host computers compose queries, and the search engine identifies pages or documents that match the queries, e.g., pages that include key words of the queries. These pages or documents are known as a result set. In many cases, ranking the pages in the result set is computationally expensive at query time.

A number of search engines rely on many features in their ranking techniques. Sources of evidence can include textual similarity between query and pages or query and anchor texts of hyperlinks pointing to pages, the popularity of pages with users measured for instance via browser toolbars or by clicks on links in search result pages, and hyper-linkage between web pages, which is viewed as a form of peer endorsement among content providers. The effectiveness of the ranking technique can affect the relative quality or relevance of pages with respect to the query, and the probability of a page being viewed.

Some existing search engines rank search results via a function that scores pages. The function is automatically learned from training data. Training data is in turn created by providing query/page combinations to human judges who are asked to label a page based on how well it matches a query, e.g., perfect, excellent, good, fair, or bad. Each query/page combination is converted into a feature vector that is then provided to a machine learning algorithm capable of inducing a function that generalizes the training data.

For common-sense queries, it is likely that a human judge can come to a reasonable assessment of how well a page matches a query. However, there is a wide variance in how judges evaluate a query/page combination. This is in part due to prior knowledge of better or worse pages for queries, as well as the subjective nature of defining “perfect” answers to a query (this also holds true for other definitions such as “excellent,” “good,” “fair,” and “bad”, for example). In practice, a query/page pair is typically evaluated by just one judge. Furthermore, judges may not have any knowledge of a query and consequently provide an incorrect rating. Finally, the large number of queries and pages on the web implies that a very large number of pairs will need to be judged. It will be challenging to scale this human judgment process to more and more query/page combinations.

Click logs embed important information about user satisfaction with a search engine and can provide a highly valuable source of relevance information. Compared to human judges, clicks are much cheaper to obtain and generally reflect current relevance. However, clicks are known to be biased by the presentation order, the appearance (e.g. title and abstract) of the documents, and the reputation of individual sites. Various attempts have been made to account for this and other biases that arise when analyzing the relationship between a click and the relevance of a search result. These models include the position model, the cascade model and the Dynamic Bayesian Network (DBN) model.

### SUMMARY

Users with different search intents may submit the same query to the search engine while expecting different search results. Thus, there might be a bias between the user search intent and the query formulated by the user, which leads to observed diversities in user clicks. In other words, the attractiveness of a search result is not only influenced by its relevance but is also determined by the user's underlying search intent behind the query. Thus, a user click may determined by both an intent bias and relevance. If a user does not clearly formulate her input query to accurately express her informational needs, there will be a large intent bias.

In one implementation, a click model is provided which incorporates a new hypothesis, which is referred to herein as the intent hypothesis. The intent hypothesis assumes that a result or snippet is clicked only after it meets the user's search intent, i.e. it is needed by the user. Since the query partially reflects the user's search intent, it is reasonable to assume that a document is never needed if it is irrelevant to the query. On the other hand, whether a relevant document is needed is uniquely influenced by the gap between the user's intent and the query.

In accordance with another implementation, a method of generating training data for a search engine begins by retrieving log data pertaining to user click behavior. The log data is analyzed based on a click model that includes a parameter pertaining to a user intent bias representing the intent of a user in performing a search in order to determine a relevance of each of a plurality of pages to a query. The relevance of the pages is then converted into training data. In one particular implementation, the click model is a graphical model that includes an observable binary value representing whether a document is clicked and hidden binary variables representing whether the document is examined by the user and needed by the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an exemplary environment 100 in which a search engine may operate.

FIG. 2 describes the triangular relationship among the intent, the query and a document found during a search session, where the edge connecting two entities measures the degree of match between two entities.

FIG. 3 is a graph of the click-through rates for each query in an experiment that was performed for two groups of search sessions with five randomly picked queries.

FIG. 4 shows the distribution of the difference between the click-through rates between the first and second groups for all of the search queries used in FIG. 3.

FIG. 5 compares the graphical models of the examination hypothesis to the intent hypothesis.

FIG. 6 is an operational flow of an implementation of a method for generating training data from click logs.

### DETAILED DESCRIPTION

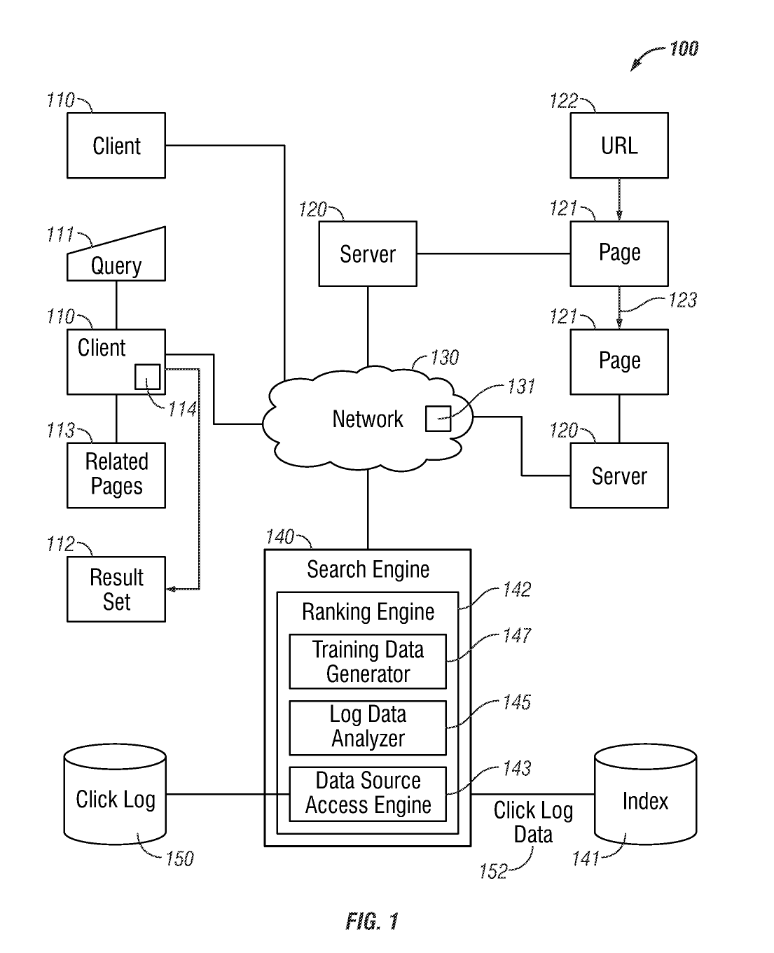

FIG. 1 illustrates an exemplary environment 100 in which a search engine may operate. The environment includes one or more client computers 110 and one or more server computers 120 (generally “hosts”) connected to each other by a network 130, for example, the Internet, a wide area network (WAN) or local area network (LAN). The network 130 provides access to services such as the World Wide Web (the “web”) 131.

The web 131 allows the client computer(s) 110 to access documents containing text-based or multimedia content contained in, e.g., pages 121 (e.g., web pages or other documents) maintained and served by the server computer(s) 120. Typically, this is done with a web browser application program 114 executing in the client computer(s) 110. The location of each page 121 may be indicated by a network address such as an associated uniform resource locator (URL) 122 that is entered into the web browser application program 114 to access the page 121. Many of the pages may include hyperlinks 123 to other pages 121. The hyperlinks may also be in the form of URLs. Although implementations are described herein with respect to documents that are pages, it should be understood that the environment can include any linked data objects having content and connectivity that may be characterized.

In order to help users locate content of interest, a search engine 140 may maintain an index 141 of pages in a memory, for example, disk storage, random access memory (RAM), or a database. In response to a query 111, the search engine 140 returns a result set 112 that satisfies the terms (e.g., the keywords) of the query 111.

Because the search engine 140 stores many millions of pages, the result set 112, particularly when the query 111 is loosely specified, can include a large number of qualifying pages. These pages may or may not be related to the user's actual information needs. Therefore, the order in which the result set 112 is presented to the client 110 affects the user's experience with the search engine 140.

In one implementation, a ranking process may be implemented as part of a ranking engine 142 within the search engine 140. The ranking process may be based upon a click log 150, described further herein, to improve the ranking of pages in the result set 112 so that pages 113 related to a particular topic may be more accurately identified.

For each query 111 that is posed to the search engine 140, the click log 150 may comprise the query 111 posed, the time at which it was posed, a number of pages shown to the user (e.g., ten pages, twenty pages, etc.) as the result set 112, and the page of the result set 112 that was clicked by the user. As used herein, the term click refers to any manner in which a user selects a page or other object through any suitable user interface device. Clicks may be combined into sessions and may be used to deduce the sequence of pages clicked by a user for a given query. The click log 150 may thus be used to deduce human judgments as to the relevance of particular pages. Although only one click log 150 is shown, any number of click logs may be used with respect to the techniques and aspects described herein.

The click log 150 may be interpreted and used to generate training data that may be used by the search engine 140. Higher quality training data provides better ranked search results. The pages clicked as well as the pages skipped by a user may be used to assess the relevance of a page to a query 111. Additionally, labels for training data may be generated based on data from the click log 150. The labels may improve search engine relevance ranking.

Aggregating clicks of multiple users provides a better relevance determination than a single human judgment. A user generally has some knowledge of the query and consequently multiple users that click on a result bring diversity of opinion. For a single human judge, it is possible that the judge does not have knowledge of the query. Additionally, clicks are largely independent of each other. Each user's clicks are not determined by the clicks of others. In particular, most users issue a query and click on results that are of interest to them. Some slight dependencies exist, e.g., friends could recommend links to each other. However, in large part, clicks are independent.

Because click data from multiple users is considered, specialization and a draw on local knowledge may be obtained, as opposed to a human judge who may or may not be knowledgeable about the query and may have no knowledge of the result of a query. In addition to more “judges” (the users), click logs also provide judgments for many more queries. The techniques described herein may be applied to head queries (queries that are asked often) and tail queries (queries that are not asked often). The quality of each rating improves because users who pose a query out of their own interest are more likely to be able to assess the relevance of pages presented as the results of the query.

The ranking engine 142 may comprise a log data analyzer 145 and a training data generator 147. The log data analyzer 145 may receive click log data 152 from the click log 150, e.g., via a data source access engine 143. The log data analyzer 145 may analyze the click log data 152 and provide results of the analysis to the training data generator 147. The training data generator 147 may use tools, applications, and aggregators, for example, to determine the relevance or label of a particular page based on the results of the analysis, and may apply the relevance or label to the page, as described further herein. The ranking engine 142 may comprise a computing device which may comprise the log data analyzer 145, the training data generator 147, and the data source access engine 143, and may be used in the performance of the techniques and operations described herein.

In a result set, small pieces of the page or document are presented to the user. These small pieces are known as snippets. It is noted that a good snippet (appearing to be highly relevant) of a document that is shown to the user could artificially cause a bad (e.g., irrelevant) page to be clicked more and similarly a bad snippet (appearing to be irrelevant) could cause a highly relevant page to be clicked less. It is contemplated that the quality of the snippet may be bundled with the quality of the document. A snippet may typically include the search title, a brief portion of text from the page or document and the URL.

It has been found that a user is more likely to click on higher ranked pages independent of whether the page is actually relevant to the query. This is known as position bias. One click model that attempts to address the position bias is the position click model. This model assumes that a user only clicks on a result if user actually examines the snippet and concludes that the result is relevant to the search. This idea was later formalized as the examination hypothesis. In addition, the model assumes that the probability of examination only depends on the position of the result. Another model, referred to as the examination click model, extends the position click model by rewarding relevant documents which are lower down in the search results by using a multiplication factor. The examination hypothesis assumes that, if a document has been examined, the click-through rate of the document for a given query is a constant number, whose value is determined by the relevance between the query and the document. Another model, referred to as the cascade click model extends the examination click model still further by assuming that the user scans the search results from top to bottom.

The aforementioned click models do not distinguish between the actual and perceived relevance of a result (i.e., a snippet). That is, when a user examines a result and deems it relevant, the user merely perceives that the result is relevant, but does not know conclusively. Only when the user actually clicks on the result and examines the page or document itself will the user be able to access whether the result is actually relevant. One model that does distinguish between the actual and perceived relevance of a result is the DBN model.

Despite their successes in solving the position-bias problem, user clicks cannot be completely explained by the relevance and the position biases. Specifically, users with different search intents may submit the same query to the search engine while expecting different search results. Thus, there might be a bias between the user search intent and the query formulated by the user, which leads to the observed diversity in user clicks. In other words, a single query may not accurately reflect user search intent. Take the query “iPad™” as an example. A user may submit this query because she wants to browse general information about the iPad, and the search results received from, say, apple.com or wikipedia.com are attractive to her. In contrast, another user who submits the same query may be looking for information such as user reviews or feedback on the iPad. In this case, search results like technical reviews and discussion forum are more likely to be clicked. This example indicates that the attractiveness of a search result is not only influenced by its relevance but is also determined by the user's underlying search intent behind the query.

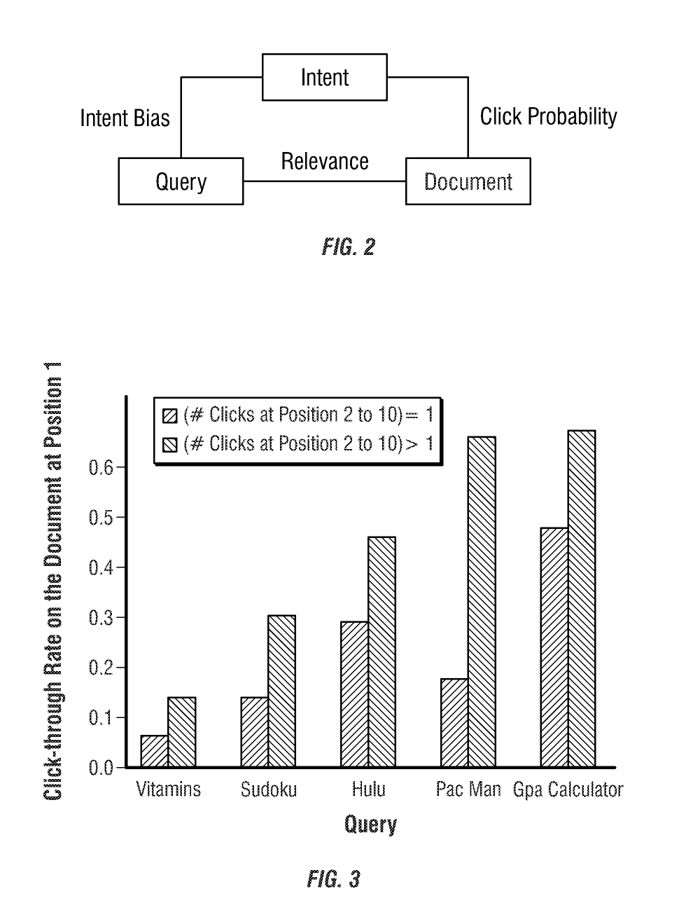

FIG. 2 describes the triangular relationship among the intent, the query and a document found during a search session, where the edge connecting two entities measures the degree of match between two entities. Each user has an intrinsic search intent before submitting a query. When a user comes to a search engine, she formulates a query according to her search intent and submits the query to the search engine. The intent bias measures the degree of matching between the intent and the query. The search engine receives the query and returns a list of ranked documents, and the relevance measures the degree of match between a query and a document. The user examines each document and is more likely to click on a document that better satisfies her informational needs in comparison to other documents.

The triangular relationship in FIG. 2 suggests that a user click is determined by both the intent bias and relevance. If a user does not clearly formulate her input query to accurately express her informational needs, there will be a large intent bias. Thus, the user is not likely to click the document that does not meet her search intent, even if the document is very relevant to the query. The examination hypothesis can be considered as a simplified case in which the search intent and the input query are equivalent and there is no intent bias. Thus, the relevance between the query and the document may be mistakenly estimated when only adopting the examination hypothesis.

The following definitions and notations may be useful for describe aspects and implementations of the methods and systems described herein. A user submits a query q and the search engine returns a search result page containing M (e.g., 10) results or snippets, denoted by

-, where is the index of the result at the i-th position. The user examines the snippet of each search result and clicks some or none of them. A search within the same query is called a search session, denoted by s. Clicks on sponsored ads and other web elements are not considered in one search session. The subsequent re-submission or re-formulation of a query is treated as a new session.

Three binary random variables, Cᵢ, Eᵢ and Rᵢ, are defined to model user clicks, user examination and document relevance events at the i-th position:

Cᵢ: whether the user clicks on the result;

Eᵢ: whether the user examines the result;

Rᵢ: whether the target document corresponding to the result is relevant

where the first event is observable from search sessions and the last two events are hidden.

is the CTR of the i-th document, Pr (Eᵢ=1) is the probability of examining the i-th document, and Pr (Rᵢ=1) is the relevance of the i-th document. The parameter rᵢ is used to represent the document relevance as

Pr(Rᵢ=1)=rπₛ (1)

Next, the previously mentioned examination hypothesis may be expressed as follows:

Hypothesis 1 (Examination Hypothesis). A result is clicked if and only if it is both examined and relevant, which is formulated as

Eᵢ=1, Rᵢ=1 [symbol] Cᵢ=1 (2)

where Rᵢ and Eᵢ are independent of each other.

Equivalently, Formula (2) can be reformulated in a probabilistic way:

Pr(Cᵢ=1|Eᵢ=1,Rᵢ=1)=1 (3)

Pr(Cᵢ=1|Eᵢ=0)=0 (4)

Pr(Cᵢ=1|Rᵢ=0)=0 (5)

After summation over Rᵢ, this hypothesis is simplified as

Pr(Cᵢ=1|Eᵢ=1)=r_{π}_{ₛ} (6)

Pr(Cᵢ=1|Eᵢ=0)=0 (7)

As a result, the document click-through rate is represented by

$$\begin{matrix}Pr ( {C}_{i} = 1 ) = {\sum }_{e ∈ \{ 0 , 1 \}} Pr ( {E}_{i} = e ) Pr ( {C}_{i} = 1 \vert {E}_{i} = e ) \\ = \underbrace{Pr ( {E}_{i} = 1 )}_{position bias} \underbrace{Pr ( {C}_{i} = 1 \vert {E}_{i} = 1 )}_{document relevance}\end{matrix}$$

where the position bias and the document relevance are de-composed. This hypothesis has been used in various click models to alleviate the position bias problem.

Another click model that was mentioned above, the cascade click model, is based on the cascade hypothesis, which may be formulated as follows:

Hypothesis 2 (Cascade Hypothesis). A user examines search results from top to bottom without skips, and the first result is always examined:

Pr(Eᵢ=1)=1 (8)

Pr(Eᵢ₊₁=1|Eᵢ=0)=0 (9)

The cascade model combines together the examination hypothesis and the cascade hypothesis, and further assumes that the user stops the examination after reaching the first click and abandons the search session:

Pr(Eᵢ₊₁=1|Eᵢ=1, Cᵢ)=1−Cᵢ (10)

However, this model is too restrictive and can only deal with search sessions having at most one click.

The dependent click model (DCM) generalizes the cascade model to include sessions with multiple clicks, and introduces a set of position-dependent parameters, i.e

Pr(Eᵢ₊₁=1|Eᵢ=1,Cᵢ=1)=λᵢ (11)

Pr(Eᵢ₊₁=1|Eᵢ=1,Cᵢ=0)=1 (12)

where represents the probability of examining the next document after a click. These parameters are global and are thus shared across all search sessions. This model assumes that a user examines all the subsequent snippets below the snippet that was last clicked. In fact, if the user is satisfied with the last clicked document, she usually does not continue to examine the subsequent search results.

The dynamic Bayesian network model (DBN) assumes the attractiveness of a snippet determines if the user clicks on it to view the corresponding document, and the user satisfaction with the document determines whether the user examines the next document. Formally speaking,

Pr(Eᵢ₊₁=1|Eᵢ=1,Cᵢ=1)=γ(1−s_{π}_{ᵢ}) (13)

Pr(Eᵢ₊₁=1|Eᵢ=1,Cᵢ=0)=γᵢ (14)

where the parameter is the probability that the user examines the next document without click, and the parameter is the user satisfaction. Experimental comparisons show that the DBN model outperforms other click models that are based on the cascade hypothesis. The DBN model employs the expectation maximization algorithm to estimate parameters, which may require a great number of iterations for convergence. A Bayesian inference method for the DBN method, the expectation propagation, is introduced in T. P. Minka, “Expectation propagation for approximate Bayesian inference.” UAI '10, pages 362-369. Morgan Kaufmann Publishers Inc.

Yet another click model, the user browsing model (UBM), is also based on the examination hypothesis, but does not follow the cascade hypothesis. Instead, it assumes that the examination probability E, depends on the position of the previously clicked snippet

as well as the distance between the i-th position and the lᵢ position:

Pr(Eᵢ=1|C_{1:i-1})=βlᵢ,i−1₄ (15)

If there are no clicks on a snippet located before the position i, lᵢ is set to 0. The likelihood of a search session under the UBM model is quite simple in form:

$$Pr ( {C}_{1 : M} ) = {\prod }_{i = 1}^{M} {( {r}_{{π}_{i}} {β}_{{l}_{i} , i - {l}_{i}} )}^{{C}_{i}} {( 1 - {r}_{{π}_{i}} {β}_{{l}_{i} , i - {l}_{i}} )}^{1 - {C}_{i}} \qquad ( 16 )$$

where there are—parameters shared across all search sessions. The Bayesian browsing model (BBM), discussed in follows the same assumptions as the UBM, but adopts a Bayesian inference algorithm.

As previously mentioned, the examination hypothesis is the basis of many of the existing click models. The hypothesis is mainly aimed at modeling the position bias in the click log data. In particular, it assumes that the probability of a click's occurrence is uniquely determined by the query and the result, after the result is examined by the user. Controlled experiments have demonstrated, however, that the assumption held by the examination hypothesis cannot completely interpret the click-through log data. Rather, given a query and an examined result, there is still a diversity among the click-through rates for this document. This phenomenon clearly suggests that the position bias is not the only bias that affects click behavior.

In one experiment, the document click-through rates were calculated for two groups of search sessions with five randomly picked queries. One group included sessions with exactly one click at the positions 2 to 10, and the other group included sessions with at least two clicks at the positions 2 to 10. For each query, the click-through rate was calculated on the same document and this document was always at the first position. The results of this experiment are shown in FIG. 3, which is a graph of click-through rates for each query.

According to the examination hypothesis, the relevance between a query and a result is a constant number, if the document has been examined. This implies that the click-through rate in the two groups should be equivalent to each other, since the document at the top position is always examined. As shown in FIG. 3, however, none of the queries presents the same click-through rate for the two groups. Instead, it is observed that the click-through rate in the second group is significantly higher than that in the first group.

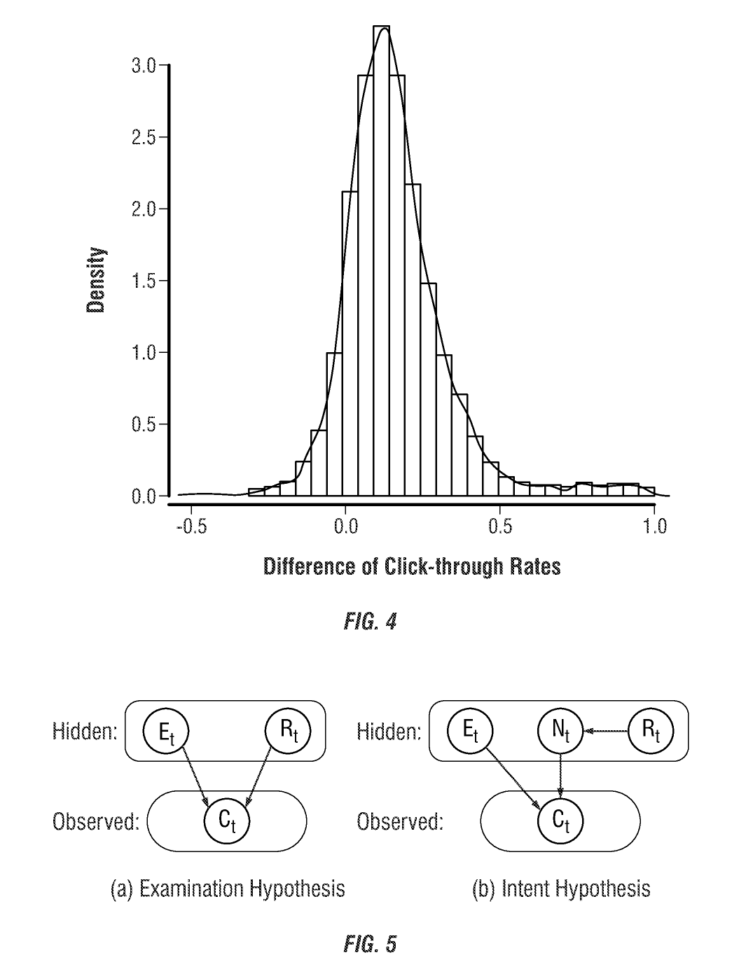

In order to further investigate this analysis, the click-through rate in the first group is subtracted from that in the second group, and the distribution of this difference is plotted over all the search queries. FIG. 4 illustrates the difference in the click-through rates between the two groups for all queries. The resulting distribution matches a Gaussian distribution whose center is at a positive value of about 0.2. Specifically, the number of queries whose corresponding difference is located in [−0.01, 0.01] occupies only 3:34% of all the queries, which indicates that the examination hypothesis does not precisely characterize the click behavior for most of the queries.

Since it is likely that the users have not read the last nine documents when they are browsing the first document, whether the first document has been clicked is an independent event with respect to any clicks that may be made on the last nine documents. Thus, the only reasonable explanation for this phenomenon is that there is an intrinsic search intent behind the query, and this intent leads to the click diversity between two groups.

This diversity can be accounted for by a new hypothesis, which is referred to herein as the intent hypothesis. The intent hypothesis preserves the concept of examination proposed by the examination hypothesis. Moreover, the intent hypothesis assumes that a result or snippet is clicked only after it meets the user's search intent, i.e. it is needed by the user. Since the query partially reflects the user's search intent, it is reasonable to assume that a document is never needed if it is irrelevant to the query. On the other hand, whether a relevant document is needed is uniquely influenced by the gap between the user's intent and the query. From this definition, if the user were to always submit a query which exactly reflects her search intent, then the intent hypothesis will be reduced to the examination hypothesis.

Formally, the intent hypothesis includes the following three statements:
1. The user will click on snippet in a list of search results to access the corresponding document if and only if it is examined and needed by the user.
2. If a document is perceived irrelevant, the user will not need it.
3. If a document is perceived relevant, whether it is needed is only influenced by the gap between the user's intent and the query.

FIG. 5 compares the graphical models of the examination hypothesis to the intent hypothesis. As can be seen in the intent hypothesis, a latent event Nᵢ is inserted between Rᵢ and Cᵢ, in order to distinguish between document relevance and the document being clicked.

It order to represent the intent hypothesis in a probabilistic way, the following notation and symbols will be introduced. Suppose that there are m results or snippets in the session s. The i-th snippet is denoted by and whether it is clicked is denoted by Cᵢ. Cᵢ is a binary variable. Cᵢ=1 represents that the snippet is clicked and Cᵢ=0 represents that it is not clicked. Similarly, whether the snippet is examined, perceived relevant and needed is respectively represented by the binary variables Eᵢ, Rᵢ and Nᵢ. Under this definition, the intent hypothesis can be formulated as:

Eᵢ=1, Nᵢ=1 [symbol] Cᵢ=1 (17)

Pr(Rᵢ=1)=r_{π}_{ₛ} (18)

Pr(Nᵢ=1|Rᵢ=0)=0 (19)

Pr(Nᵢ=1|Rᵢ=1)=μₛ (20)

Here, is the relevance of the snippet, and is defined as the intent bias. Since the intent hypothesis assumes that should only be influenced by the intent and the query, is shared across all snippets in the same session, which means that it is a global latent variable in session s. However, it will generally be different in different sessions since the intent bias will generally be different.

Combining equations (17), (18), (19) and (20), it is not difficult to derive that:

Pr(Cᵢ=1|Eᵢ=1)=μₛr_{π}_{ₛ} (21)

Pr(Cᵢ=1|Eᵢ=0)=0 (22)

Compared to equation (6), which is derived from the examination hypothesis, equation (21) adds a coefficient to the original relevance. Intuitively, it can be seen that a discount is taken off its relevance.

For click models such as those mentioned above which are based on the examination hypothesis, the switch from the examination hypothesis to the intent hypothesis is quite simple. Actually, formula (6) only needs to be replaced with the formula (21), without changing any other specifications. Here, the latent intent bias is local for each session s. Every session maintains its own intent bias, and the intent biases for different sessions are mutually independent of one another.

When the intent hypothesis is adopted to construct or reconstruct a click model, the resulting click model is referred to herein as an unbiased model. For purposes of illustration two click models, the DBN and UBM models, will to illustrate the impact of the intent hypothesis. The new model based on DBN and UBM will be referred to as the Unbiased-DBN and Unbiased-UBM models, respectively.

As noted above, when an unbiased model is constructed, the value of should be estimated for each session. After all of the are known, then the other parameters (such as relevance) of the click model should be determined. However, since the estimation o f might also depend rely on the values that are determined for the other parameters of the model, the entire inference process could come to a standstill. To avoid this problem, an iterative inference process may be adopted, which is shown in Table 1.

TABLE 1
Algorithm 1 Iterative inference of unbiased model

```
Require: Given a set S of sessions to train and an original
  click model M (Its own parameter set is denoted by ⊖.)
1: Initialize the intent bias μₛ ← 1 for each session s in S.
2: repeat
3: Phase A: We learn every parameters in ⊖ using the
  original inference method of M while we fix the values
  of μₛ according to the latest estimated values of μₛ.
4: Phase B: We estimate the value of μₛ for each session,
  using maximum-likelihood estimation, under the
  learning result of parameters ⊖ generated in phase A.
5: until all parameters converge
```

As shown in Table 1, every iteration consists of two phases. In Phase A, the click model parameters are determined based on the estimated values of obtained from the last iteration. In Phase B, the value of is estimated for each session based on the parameters determined in Phase A. The value of may be estimated by maximizing a likelihood function, which in this case is the conditional probability that the actual click events performed during this session occurs as specified by the click model, with being treated as the condition. Phase A and Phase B should be executed alternatively and iteratively until all the parameters converge.

This general inference framework can be modified to be more efficient if the parameters other than ₛ could be determined using an online Bayesian inference approach. In such a case, the inference remains in an online mode (i.e., a mode in which input sessions are sequentially received) even after the estimations of are included. Specifically, when a session is received or loaded in, the posterior distributions determined from the previous sessions are used to obtain an estimation of. Then the estimated value of ₛ is used to update the distribution of the other parameters. Since The distribution of every parameter undergoes little change before and after the update, it is not necessary to re-estimate the value of, and thus no iterative steps are needed. Accordingly, after all the parameters have been updated, the next session is loaded and the process continues.

As described above, both the UBM and DBN models may employ the Bayesian paradigm to infer the model parameters. According to the aforementioned method, when a new incoming query session is to be used as training data, three steps are to be executed:

Integrate over all the parameters except to derive the likelihood function

Maximize the likelihood function to estimate the value of.

Fix the value of and update the other parameters using the Bayesian inference method.

Such an online Bayesian inference process facilitates the use of singe-pass and incremental computation, which is advantageous when very large-scale data processing is involved.

Given a query session which is not being used as training data, the joint probability distribution of the click events in this session can be calculated from the following formula:

Pr(C_{1:m})=∫₀¹Pr(C_{1:m}|μₛ)p(μₛ)d(μₛ) (23)

In order to determine, the distribution of the estimated in the training process is investigated and a density histogram of ₛ is prepared for each query. The density histogram is then used to approximate. In one implementation, the range [0,1] is evenly divided into 100 segments, and the density of which fall into each of segments is counted. The result is treated as the density distribution.

It is worth noting that this method is not able to predict the exact value of the intent bias for sessions that are not included in the training set. This is because the intent bias can only be estimated when the actual user clicks are available, but in the testing data, the user click is hidden and is unknown to the click model. Thus, the predicted result of future clicks is averaged over all the intent biases according to the intent bias distribution obtained from the training set. This averaging step gives up the advantages of the intent hypothesis. In an extreme case that a query never occurs in the training data, the intent bias may be set to 1, where the intent hypothesis reduces to the examination hypothesis and predicts the same results as the original model.

As an example of the process, the User Browsing Model (UBM) will now be presented as an example to demonstrate how the intent hypothesis can be applied to a click model. A Bayesian inference procedure to estimate the parameters are also introduced.

Given a search session s, the UBM model uses the relevance of the documents and the transition probabilities as its parameters. As previously mentioned, the parameters in this model are denoted by In addition, if the intent hypothesis is to be applied to the UBM model, then a new parameter should be included. This parameter is the intent bias for session s, which is denoted by. Under the intent hypothesis, the revised version of the UBM model is formulated by (21), (22) and (15).

In accordance with the model's requirements, the likelihood for session s can be derived as:

$$\begin{matrix}\begin{matrix}Pr ( s \vert Θ , {μ}_{s} ) {=}^{Δ} Pr ( {C}_{1 : M} \vert Θ , {μ}_{s} ) \\ = {\prod }_{i = 1}^{M} {\sum }_{k = 0}^{1} [ Pr ( {C}_{i} \vert {E}_{i} = k , {μ}_{s} , {r}_{{π}_{i}} ) \cdot Pr ( {E}_{i} = k \vert \text{?} \text{?} ) ] \\ = {\prod }_{i = 1}^{M} {( {μ}_{s} \text{?} \text{?} )}^{{C}_{i}} {( 1 - {μ}_{s} \text{?} \text{?} )}^{1 - {C}_{i}} ( 25 )\end{matrix} & ( 24 ) \\ \text{?} \text{indicates text missing or illegible when filed} & \end{matrix}$$

Here, Cᵢ represents whether the result at the position i is clicked. The overall likelihood for the entire dataset is the product of the likelihood for every single session.

The parameters for the model may be inferred with the use of the Bayesian paradigm. The learning process is incremental: the search sessions are loaded and processed one by one, and the data for each session is discarded after it has been processed in the Bayesian inference process. Given a new incoming session s, the distribution of each parameter is updated based on the session data and the click model. Before the update, each parameter has a prior distribution p( ). The likelihood function P is computed and multiplied by the prior distribution p( ), and the posterior distribution P is derived. Finally, the distribution of is updated with respect to its posterior distribution.

Examining the updating procedure in more detail, the likelihood function (25) is first updated over to derive a marginal likelihood function only occupied by the intent bias:

Pr(s|μₛ)=∫_{R}_{^{|⊖|}}p(⊖)Pr(s|⊖,μₛ)d⊖

Since is a unimodal function, it can be maximized by a ternary searching procedure on the parameter, which is in the range of [0, 1]. The optimal value for is then denoted by.

Once is optimized, the posterior distribution is derived for each parameter via the Bayes' Rule:

p(θ|s,μₛ=μₛ^{•})∝p(θ)∫_{R}_{^{|⊖′|}}Pr(s|⊖,μₛ=μₛ^{•})p(⊖′)d⊖′
where ⊖′=⊖\{θ} for short notation.

The final step is to update p( ) according to. To make the whole inference process tractable, it is usually necessary to restrict the mathematical form of p( ) to a specific distribution family. In this example the Probit Bayesian Inference (PBI), discussed in Y. Zhang, D. Wang, G. Wang, Z. Zhang, and W. Chen. “Learning click models via probit Bayesian inference.” CIKM '10, page to appear, is used to obtain the final update. PBI connects each with an auxiliary variable through the probit link, and restricts p(x) so that it is always in the Gaussian family. Thus, in order to update p(x), it is sufficient to derive from and approximate it by a Gaussian density. Then the approximation is used to update p(x) and further update p( ). Since the learning process is incremental, the update procedure is executed once for each session.

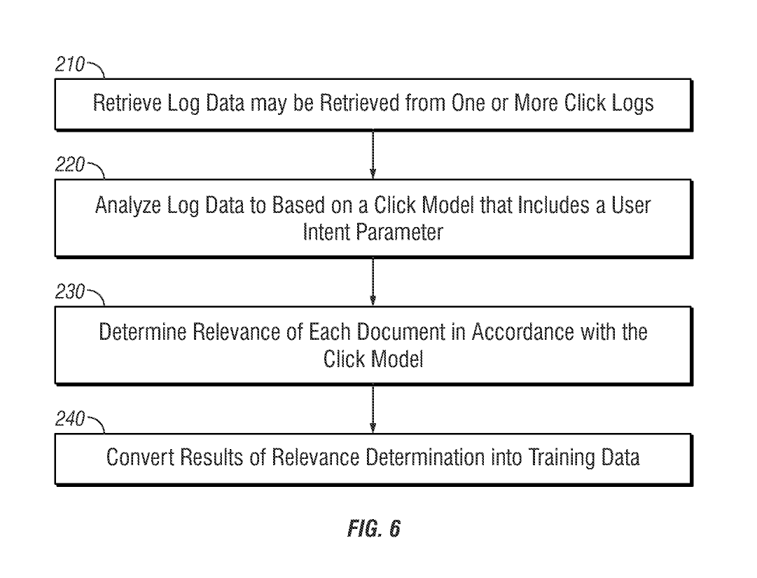

FIG. 6 is an operational flow of an implementation of a method 200 of generating training data from click logs. At 210, log data may be retrieved from one or more click logs and/or any resource that records user click behavior such as toolbar logs. The log data may be analyzed at 220 to calculate click model parameters in the manner described above. Next, at 230 the relevance of each document is determined from the log data. At 240, the results of the relevance determination may be converted into training data. In one implementation, the training data may comprise the relevance of a page with respect to another page for a given query. The training data may take the form that one page is more relevant than another page for the given query. In other implementations, a page may be ranked or labeled with respect to the strength of its match or relevance for a query. The ranking may be numerical (e.g., on a numerical scale such as 1 to 5, 0 to 10, etc.) where each number pertains to a different level of relevance or textual (e.g., “perfect”, “excellent”, “good”, “fair”, “bad”, etc.).

As used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications may be made to this configuration without departing from the scope or spirit of the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of generating training data for a search engine, comprising:
retrieving log data pertaining to user click behavior;
analyzing the log data based on a click model that includes a parameter pertaining to a user intent bias representing the intent of a user in performing a search in order to determine a relevance of each of a plurality of pages to a query; and
converting the relevance of the pages into training data.

2. The method of claim 1 wherein the user intent bias is determined by a relationship between a query performed by the user through the search engine to obtain a document included among search results and document relevance.

3. The method of claim 1 wherein the click model is a graphical model that includes an observable binary value representing whether a document is clicked and hidden binary variables representing whether the document is examined by the user and needed by the user.

4. The method of claim 1 wherein the click model is a DBN model that is reconstructed to include the parameter pertaining to the user intent bias.

5. The method of claim 1 wherein the click model is a UBM model that is reconstructed to include the parameter pertaining to the user intent bias.

6. The method of claim 1 wherein a plurality of model parameters are associated with the click model and further comprising:
determining values for each of the plurality of model parameters for a series of training query sessions using an initialized value for the parameter pertaining to the user intent bias;
estimating, for each query session, a value for the parameter pertaining to the user intent bias using the values for each of the model parameters that have been determined;
repeating the determining and estimating steps in an iterative manner until all the parameters converge.

7. The method of claim 6 wherein the determining and estimating steps are performed with a likelihood-based inference using a probabilistic graphical model.

8. The method of claim 7 wherein the probabilistic graphical model is a Bayesian network.

9. The method of claim 6 further comprising, for each query session:
integrating over all the model parameters to derive a likelihood function;
maximizing the likelihood function to estimate the value of the parameter pertaining to the user intent bias; and
updating the model parameters using the value of the parameter pertaining to the user intent bias that has been estimated.

10. The method of claim 1 wherein the click model weighs more highly clicked pages that appear lower in a list of query results than clicked pages that appear higher in the list of query results.

11. The method of claim 1 wherein retrieving log data comprises retrieving the log data from a click log.

12. A computer-readable medium comprising computer-readable instructions for generating training data, said computer-readable instructions comprising instructions that:
retrieve log data from a click log, the log data comprising a query, a result set and at least one page of the result set that was clicked by a user;
analyze the log data based on a click model that includes a parameter pertaining to a user intent bias representing the intent of a user in performing a search in order to determine a relevance of each of a plurality of pages to a query; and
provide each of the pages with a ranking based on the relevance of each of the pages for the query.

13. The computer-readable medium of claim 12, wherein the ranking comprises a label.

14. The computer-readable medium of claim 12, wherein the ranking is numerical or textual.

15. The computer-readable medium of claim 12, further comprising instructions that provide the ranking of each of the pages to a search engine as training data.

16. The computer-readable medium of claim 12, wherein the click model is a graphical model that includes an observable binary value representing whether a document is clicked and hidden binary variables representing whether the document is examined by the user and needed by the user.

17. The computer-readable medium of claim 12 wherein a plurality of model parameters are associated with the click model and further comprising:
determining values for each of the plurality of model parameters for a series of training query sessions using an initialized value for the parameter pertaining to the user intent bias;
estimating, for each query session, a value for the parameter pertaining to the user intent bias using the values for each of the model parameters that have been determined;
repeating the determining and estimating steps in an iterative manner until all the parameters converge.

18. The computer-readable medium method of claim 17 wherein the determining and estimating steps are performed with a likelihood-based inference using a probabilistic graphical model.

19. The computer-readable medium of claim 18 wherein the probabilistic graphical model is a Bayesian network.

20. The computer-readable medium of claim 19 further comprising, for each query session:
integrating over all the model parameters to derive a likelihood function;
maximizing the likelihood function to estimate the value of the parameter pertaining to the user intent bias; and
updating the model parameters using the value of the parameter pertaining to the user intent bias that has been estimated.
